(19) United States
(12) Patent Application Publication
(10) Pub. No.: US 2020/0004708 A1
(43) Pub. Date: Jan. 2, 2020

(54) I2C DATA COMMUNICATION SYSTEM AND METHOD

(71) Applicant: HONGFUJIN PRECISION ELECTRONICS (TIANJIN) CO.,LTD., Tianjin (CN)

(72) Inventor: XIAO-LONG ZHOU, Tianjin (CN)

(21) Appl. No.: 16/040,912

(22) Filed: Jul. 20, 2018

(30) Foreign Application Priority Data
Jun. 28, 2018 (CN) 201810685617.X

(51) Int. Cl. G06F 13/362; G06F 13/42

(52) U.S. Cl. CPC G06F 13/362; G06F 2213/0016; G06F 13/4282

(57) ABSTRACT

A data communication system applied in an Inter-Integrated Circuit (I2C) bus to enable functioning without a buffer or hub includes a complex programmable logic device (CPLD), a master device, and a plurality of slave devices. The CPLD detects changes in level of the SDA signal of the I2C bus between the master device and one of the slave devices, and determines a direction of an SDA signal as being from the I2C bus of the master device or from the I2C bus of the slave device.

### FIELD

The subject matter herein generally relates to data communications.

### BACKGROUND

In general, in some special Inter-Integrated Circuit (I2C) buses, drive chips such as buffers or hubs can be used to solve the problem of the 12C control. There is no extra space to place these I2C bus drive chips on a high-density single-board.

### BRIEF DESCRIPTION OF THE DRAWINGS

Implementations of the present disclosure will now be described, by way of example only, with reference to the attached figures.

FIG. 1 is a block diagram of an exemplary embodiment of a data communication system.

FIG. 2 is a schematic diagram of a complex programmable logic device (CPLD) of the system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “comprising” means “including, but not necessarily limited to”; it specifically indicates open-ended inclusion or membership in a so-described combination, group, series, and the like.

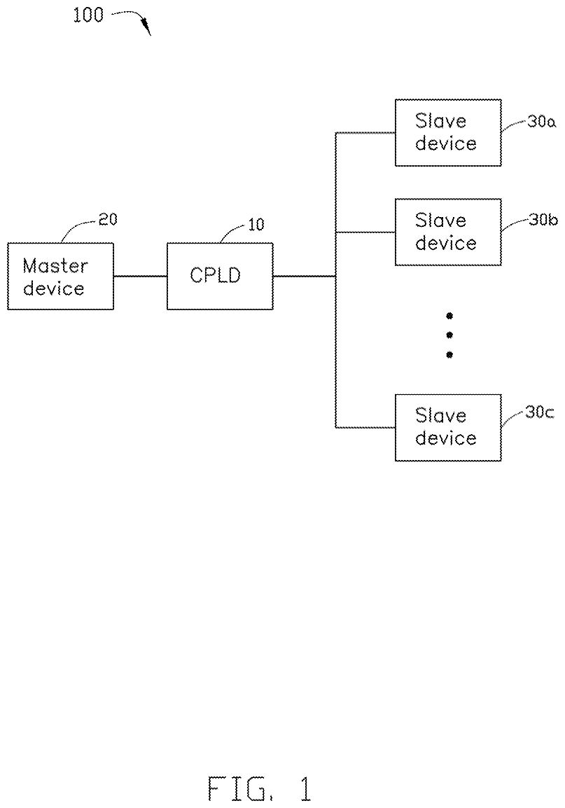

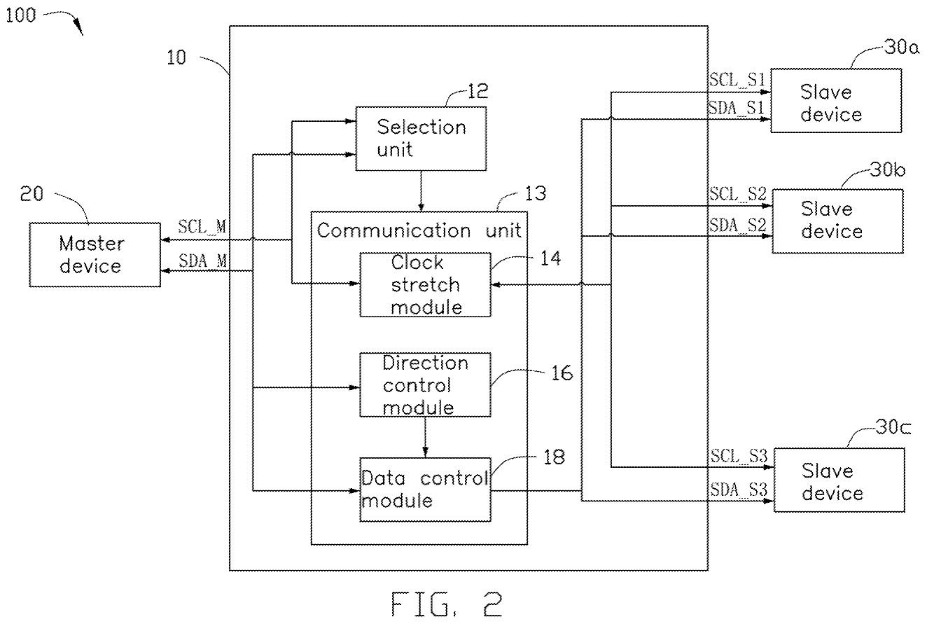

FIG. 1 illustrates a data communication system 100 in accordance with an exemplary embodiment. FIG. 2 illustrates a complex programmable logic device 10 in accordance with an exemplary embodiment. The data communication system 100 includes a complex programmable logic device (CPLD) 10, a master device 20, and a plurality of slave devices.

The CPLD 10 facilitates communication between the master device 20 and the plurality of slave devices by data transmission. In this exemplary embodiment, the plurality of slave devices includes slave devices 30a, 30b, and 30c.

In FIG. 2, an Inter-Integrated Circuit (I2C) bus (SCL_M, SDA_M) starting from the master device 20 can connect with a plurality of I2C buses (SCL_S1, SDA_S1; SCL_S2, SDA_S2; SCL_S3, SDA_S3) under processing by an I2C transparent bridge of the CPLD 10.

The CPLD 10 receives serial data line (SDA) signal and serial clock line (SCL) signal from the I2C bus of the master device 20 and the slave devices 30a, 30b, 30c in real time.

The CPLD 10 detects changes in levels of the SDA signal of the I2C bus between the master device 20 and the slave devices 30a, 30b, 30c, and determines a direction of an SDA signal, which may be from the I2C bus of the master device 20 or from the I2C bus of the slave device.

The CPLD 10 includes a selection unit 12 and a communication unit 13.

In at least one exemplary embodiment, the selection unit 12 establishes a connection to one of the slave devices 30a, 30b and 30c corresponding to the master device 20.

For example, the master device 20 can select a connection with the slave device 30b through the selection unit 12. The master device 20 can further select the connection with the slave device 30c through the selection unit 12.

In at least one exemplary embodiment, the communication unit 13 includes a clock stretch module 14, a direction control module 16, and a data control module 18.

The clock stretch module 14 supports clock stretching of the I2C bus SCL signal by the slave devices 30a, 30b, and 30c.

For example, if the master device 20 is ready to transmit data to the slave device 30a but the slave device 30a is not ready, the slave device 30a will pull the SCL signal line SCL_S1 low and maintain the low level (e.g., logic 0) to send a request to suspend transmission. The clock stretch module 14 can detect that the slave device 30a has pulled the SCL signal line low, and can pull the SCL signal line SCL_M of the master device 20 to a low level and maintain the low level.

During this process, the clock stretch module 14 will detect the state of the change in level of the SCL signal line SCL_S1 of the slave device 30a in real time.

If the clock stretch module 14 detects that the SCL signal line SCL_S1 of the slave device 30a is at the low level, the SCL signal line SCL_M of the master device 20 is pulled low and maintained at the low level. At this time, data transmission between the master device 20 and the slave device 30a is suspended.

If the clock stretch module 14 detects that the SCL signal line SCL_S1 of the slave device 30a is at a high level (e.g., logic 1), indicating that the slave device 30a has released the SCL signal line SCL_S1, the clock stretch module 14 releases the SCL signal line SCL_M of the master device 20. At this time, the master device 20 can resume data transmission with the slave device 30a.

In at least one exemplary embodiment, in the idle state, the SDA signals of the I2C bus of the master device and the slave device are both at a high level (such as logic 1).

The direction control module 16 determines the direction of an SDA signal by detecting the changes in level of the SDA signal of the I2C bus between the master device 20 and the slave devices 30a, 30b and 30c.

For example, when the master device 20 selects a connection with the slave device 30b through the selection unit 12, the direction control module 16 will detect the level change of the SDA signal of the I2C bus between the master device 20 and the slave devices 30a, 30b and 30c.

If the direction control module 16 first detects that the SDA signal of the I2C bus of the master device 20 changes from the high level to the low level, the direction control module 16 will pull the SDA signal line SCL_S2 of the slave device 30b low and maintain the low level. Here, the direction of the SDA signal is from the master device 20 to the slave device 30b. In this state, the direction control module 16 will only detect the change in level of the SDA signal from the master device 20.

Then, when the direction control module 16 detects that the SDA signal of the I2C bus of the master device 20 returns to the high level, the direction control module 16 will release the SDA signal line SCL_S2 of the I2C bus of the slave device 30b, and the SDA signal of the I2C bus of the slave device 30b changes to the high level.

The SDA signals of the master device 20 and the slave device 30b are both at the high level state, the direction of the SDA signal is not controlled by the direction control module 16, and the master device 20 and the slave device 30b can continue to communicate in accordance with the I2C protocol identification direction. In this state, the direction control module 16 can detect the level change of the SDA signal of the master device 20 and the slave device 30b at the same time.

If the direction control module 16 first detects that the SDA signal of the I2C bus of the slave device 30b changes from the high level to the low level, the direction control module 16 will pull the SDA signal line SCL_M of the master device 20 low and maintain the low level. Here, the direction of the SDA signal is from the slave device 30b to the master device 20. In this state, the direction control module 16 will only detect the level change of the SDA signal from the slave device 30b.

Then, when the direction control module 16 detects that the SDA signal of the I2C bus of the slave device 30b returns to the high level state, the direction control module 16 releases the SDA signal line SCL_M of the I2C bus of the master device 20, and the SDA signal of the I2C bus of the master device 20 changes to the high level state.

The SDA signals of the master device 20 and the slave device 30b are both at the high level state, the direction of the SDA signal is not controlled by the direction control module 16. The master device 20 and the slave device 30b can continue to communicate in accordance with the I2C protocol identification direction. In this state, the direction control module 16 can detect the level change state of the SDA signal of the master device 20 and the slave device 30b at the same time.

In at least one exemplary embodiment, the data control module 18 selects the direction of the SDA signal according to the direction of an SDA signal as determined by the direction control module 16.

For example, when the data transmission is from the master device 20 to the slave device 30b, the SDA_M of the master device 20 outputs a signal, thus the first I/O pin direction of the CPLD 10 is an input. The SDA_S2 of the slave device 30b is also an input, and the second I/O pin direction of the CPLD 10 is an output.

When the data transmission is from the slave device 30b to the master device 20, the SDA_S2 of the slave device 30b is an output, and the second I/O pin direction of the CPLD 10 is an input. The SDA_M of the master device 20 is an input, and the first I/O pin direction of the CPLD 10 is an output.

The exemplary embodiments shown and described above are only examples. Many details are often found in the art such as the other features of data communication system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. A data communication system, comprising:
a master device and a plurality of slave devices; and
a complex programmable logic device (CPLD) coupling between the master device and the plurality of slave devices, and receiving serial data line (SDA) signal and serial clock line (SCL) signal from an Inter-Integrated Circuit (I2C) bus of the master device and an I2C bus of the plurality of slave devices; and
wherein the master device selects a communication connection with one of the plurality of slave devices through the CPLD; and
wherein the CPLD detects change in level of the SDA signal between the I2C bus of the master device and the I2C bus of the one of the plurality of slave devices, and determines a direction of a current SDA signal between an SDA signal from the I2C bus of the master device and an SDA signal from the I2C bus of the one of the plurality of slave devices;
wherein the CPLD comprises a communication unit, the communication unit comprises a clock stretching module, and the clock stretching module supports clock stretching of the I2C bus SCL signal by the one of the plurality of slave devices;
wherein the CPLD comprises a selection unit, the master device selects the communication connection with the one of the plurality of slave devices through the selection unit;
wherein the communication unit further comprises a direction control module, and the direction control module detects level change state of the SDA signal of the I2C bus between the master device and the one of the plurality of slave devices, and determines a direction of a current SDA signal between an SDA signal from the I2C bus of the master device and an SDA signal from the I2C bus of the one of the plurality of slave devices; and
wherein when the direction control module first detects that the SDA signal of the I2C bus of the master device changes from the high level to the low level, the direction control unit pulls a SDA signal line of the slave device low and maintains at a low level, and the direction of the current SDA signal is from the master device to the one of the plurality of slave devices.

2. (canceled)

3. (canceled)

4. (canceled)

5. (canceled)

6. The data communication system of claim 1, wherein when the direction control module first detects that the SDA signal of the I2C bus of the one of the plurality of slave devices changes from the high level to the low level, the direction control unit pulls a SDA signal line of the master device low and maintains at the low level, and the direction of the current SDA signal is from the one of the plurality of slave devices to the master device.

7. The data communication system of claim 6, wherein the communication unit further comprises a data control module, the data control module selects the direction of the SDA signal according to the direction of current SDA signal determined by the direction control module.

8-13. (canceled)
